(19) United States
(12) Patent Application Publication
(10) Pub. No.: US 2025/0189333 A1
(43) Pub. Date: Jun. 12, 2025

(54) METHOD AND APPARATUS FOR GUIDING DRIVING INFORMATION

(71) Applicant: 42DOT INC., Seoul (KR)

(72) Inventors: Seung Hyun Ji, Seoul (KR); Ho Sung Kim, Goyang (KR)

(21) Appl. No.: 18/976,583

(22) Filed: Dec. 11, 2024

(30) Foreign Application Priority Data
Dec. 12, 2023 (KR) 10-2023-0179468

(51) Int. Cl. G01C 21/36

(52) U.S. Cl. CPC G01C 21/3626

(57) ABSTRACT

Provided are a method and apparatus for presenting driving information. The method of presenting driving information includes determining, in response to a vehicle starting to drive, whether a first condition for initiating a background route guidance is met, initiating the background route guidance, in response to meeting of the first condition, determining whether a second condition for switching the background route guidance to a foreground route guidance is met, receiving, in response to meeting of the second condition, a user input indicating whether to initiate the foreground route guidance, and initiating, in response to the receiving of the user input, the foreground route guidance.

### CROSS-REFERENCE TO RELATED APPLICATION

This application is based on and claims priority under 35 U.S.C. § 119 to Korean Patent Application No. 10-2023-0179468, filed on Dec. 12, 2023, in the Korean Intellectual Property Office, the disclosure of which is incorporated by reference herein in its entirety.

### BACKGROUND

### 1. Field

The present disclosure relates to a method and apparatus for presenting driving information.

### 2. Description of the Related Art

Advances in vehicle navigation technology have made it easier for users, such as drivers, to navigate routes without having to check maps every time, and in recent years, real-time traffic conditions may also be reflected in information provided by navigation systems.

Additionally, as the functionality of mobile devices such as smartphones has improved, navigation services may be easily provided even without a dedicated navigation device.

Meanwhile, these navigation services may generally be provided by searching for a route based on the destination input by a user, and then guiding the route selected by the user.

### SUMMARY

The present disclosure provides a method and apparatus for presenting driving information. The objectives to be solved by the present disclosure are not limited to the objectives mentioned above, and other objectives and advantages of the present disclosure that are not mentioned may be understood by the following description and will be more clearly understood by the embodiments of the present disclosure. In addition, it will be appreciated that the objectives and advantages to be solved by the present disclosure may be realized by the means and combinations thereof indicated in the claims.

Additional aspects will be set forth in part in the description which follows and, in part, will be apparent from the description, or may be learned by practice of the presented embodiments of the disclosure.

A first aspect of the present disclosure may provide a method of presenting driving information, the method including determining, in response to a vehicle starting to drive, whether a first condition for initiating a background route guidance is met, initiating the background route guidance, in response to meeting of the first condition, determining whether a second condition for switching the background route guidance to a foreground route guidance is met, receiving, in response to meeting of the second condition, a user input indicating whether to initiate the foreground route guidance, and initiating, in response to the receiving of the user input, the foreground route guidance.

A second aspect of the present disclosure provides an apparatus for presenting driving information, the apparatus including a memory storing at least one program, a processor configured to operate by executing the at least one program, wherein the processor is further configured to determine, in response to a vehicle starting to drive, whether a first condition for initiating a background route guidance is met, initiate the background route guidance, in response to meeting of the first condition, determine whether a second condition for switching the background route guidance to a foreground route guidance is met, receive, in response to meeting of the second condition, a user input indicating whether to initiate the foreground route guidance, and initiate, in response to the receiving of the user input, the foreground route guidance.

A third aspect of the present disclosure may provide a computer-readable recording medium having recorded thereon a program for causing the method according to the first aspect to execute on a computer.

### BRIEF DESCRIPTION OF THE DRAWINGS

The above and other aspects, features, and advantages of certain embodiments of the disclosure will be more apparent from the following description taken in conjunction with the accompanying drawings in which:

FIG. 1 is a diagram illustrating an example of a system including a vehicle and a control server, according to an embodiment;

FIG. 2 is a diagram schematically illustrating a device mounted on a vehicle, according to an embodiment;

FIG. 3 is a diagram for describing a foreground route guidance of the present disclosure;

FIG. 4A and FIG. 4B are diagrams for describing a basic driving guidance of the present disclosure;

FIG. 5 is a diagram for describing a background route guidance of the present disclosure;

FIG. 6 is a flowchart of a process of initiating a background route guidance according to an embodiment of the present disclosure;

FIG. 7 is a flowchart of a process of switching a background route guidance to a foreground route guidance, according to an embodiment of the present disclosure;

FIG. 8 is a flowchart of a process of generating a driving pattern, according to an embodiment of the present disclosure;

FIG. 9 is a flowchart of a method of presenting driving information, according to an embodiment of the present disclosure; and

FIG. 10 is a block diagram of an apparatus for presenting driving information, according to an embodiment of the present disclosure.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

The advantages and features of the present disclosure and the methods for achieving them will become apparent by referring to the embodiments described in detail together with the accompanying drawings. However, the present disclosure is not limited to the embodiments presented below, but may be implemented in various different forms, and should be understood to include all transformations, equivalents, or substitutes included in the spirit and technical scope of the present disclosure. The examples set forth below are provided to ensure that the present disclosure is complete and will fully convey the scope of the present disclosure to those skilled in the art to which the present disclosure pertains. In the description of the present disclosure, certain detailed explanations of related art are omitted when it is deemed that they may unnecessarily obscure the essence of the present disclosure.

The terms used in the present specification are merely used to describe particular embodiments, and are not intended to limit the present disclosure. An expression used in the singular encompasses the expression of the plural, unless it has a clearly different meaning in the context. In the present application, it should be understood that terms such as “include” or “have” are intended to specify the presence of a feature, number, step, operation, component, part or combination thereof described in the specification, but do not exclude in advance the possibility of the presence or addition of one or more other features, numbers, steps, operations, components, parts or combinations thereof.

Some embodiments of the present disclosure may be described in terms of functional block components and various processing steps. Such functional blocks may be realized by any number of hardware and/or software components configured to perform the specified functions. For example, the functional blocks of the present disclosure may be implemented by one or more microprocessors or by circuit configurations for a given function. Additionally, for example, the functional blocks of the present disclosure may be implemented in various programming or scripting languages. The functional blocks may be implemented as algorithms that execute on one or more processors. Furthermore, the present disclosure could employ any number of conventional techniques for electronics configuration, signal processing and/or control, data processing and the like. Terms such as “mechanism”, “element”, “means”, and “composition” may be used broadly and are not limited to mechanical and physical configurations.

Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device.

Hereinafter, a ‘vehicle’ may refer to any type of transportation that has a mechanism and is used to move people or things, such as a car, bus, motorcycle, kickboard, or truck.

The present disclosure will be described in detail with reference to the attached drawings below.

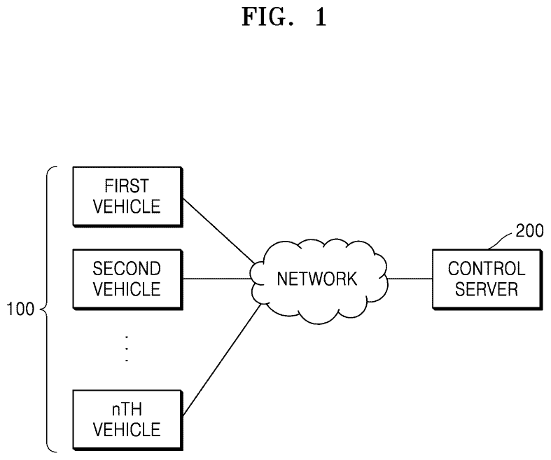

FIG. 1 is a diagram illustrating an example of a system including a vehicle and a control server, according to an embodiment.

The system according to an embodiment may include one or more vehicles 100 and a control server 200.

The vehicle 100 may communicate with each other or with other nodes through a network.

The vehicle 100 may also be understood as a device mounted on each vehicle 100.

In an embodiment, the device mounted on each vehicle 100 may be an autonomous driving device. The autonomous driving device may refer to a device that is installed in each vehicle 100 and configured to implement an autonomous driving vehicle.

The device mounted on each vehicle 100 may include various sensors (including cameras) to collect information about the surrounding situation. For example, the device mounted on each vehicle 100 may detect movement of a preceding vehicle driving ahead through an image sensor and/or an event sensor mounted on the front of each vehicle 100. The device mounted on each vehicle 100 may further include sensors for detecting the front of each vehicle 100, as well as other vehicles driving in the adjacent lane and pedestrians around each vehicle 100. The device mounted on each vehicle 100 may further include various types of sensors for collecting information about the surroundings of each vehicle 100.

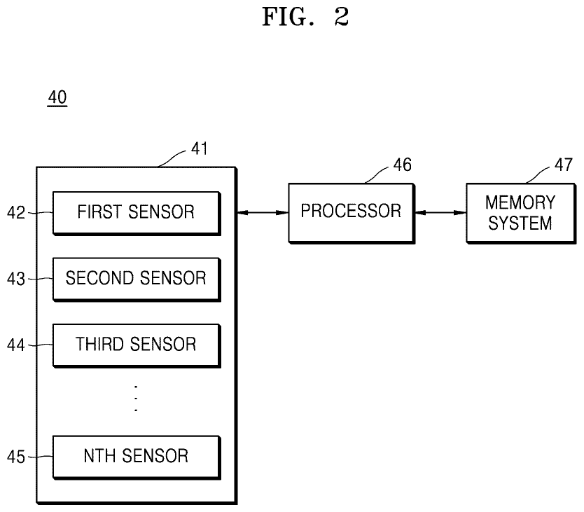

FIG. 2 is a diagram schematically illustrating a device mounted on a vehicle, according to an embodiment.

The device 40 mounted on the vehicle of FIG. 2 may be the device mounted on the vehicle 100 described above with reference to FIG. 1.

Referring to FIG. 2, the device 40 mounted on a vehicle may include a sensor unit 41, a processor 46, and a memory system 47. The device 40 mounted on the vehicle may further include a body control module (BCM) (not shown).

The sensor unit 41 may include a plurality of sensors (including cameras) 42-45, and the plurality of sensors 42-45 may include sensors for collecting information about the vehicle itself or the environment around the vehicle, such as an image sensor, an event sensor, a light sensor, a global positioning system (GPS) device, and an acceleration sensor.

Data collected by the sensors 42-45 may be transmitted to the processor 46. The processor 46 may store data collected by the sensors 42-45 in the memory system 47 and control the body control module based on the data collected by the sensors 42-45 to determine the movement of the vehicle. The memory system 47 may include two or more memory devices and a system controller for controlling the memory devices. Each of the memory devices may be provided as a single semiconductor chip.

In addition to the system controller of the memory system 47, each memory device included in the memory system 47 may include a memory controller, and the memory controller may include an artificial intelligence (AI) computational circuit such as a neural network. The memory controller may generate operation data by giving a certain weight to data received from the sensors 42-45 or the processor 46 and store the operation data in a memory chip.

Returning to FIG. 1, the device mounted on each vehicle 100 may transmit data collected from various sensors to devices mounted on other vehicles or to the control server 200.

The vehicle 100 may include a smartphone, a tablet personal computer (PC), a PC, a smart TV, a mobile phone, a laptop, or other mobile or non-mobile computing device. Additionally, the vehicle 100 may include a wearable device such as glasses or a hair band equipped with communication functions and data processing functions. The vehicle 100 may include any type of device capable of communicating with other devices over a network.

For example, the vehicle 100 may have a touch screen and include a touch input means. A touch screen is a screen on which certain information may be input through user gestures. The user gestures may include a tap, double tap, press (touch&hold), long press, drag, panning, flick, drag&drop, and release.

The control server 200 may be implemented as a computer device or a plurality of computer devices that communicate through a network to provide commands, codes, files, content, services, etc.

The vehicle 100 and the control server 200 may communicate using a network. The control server 200 may transmit and receive data with the vehicle 100 through a network, and may perform various control functions of the control server 200 or assist in driving the vehicle 100.

For example, the control server 200 may transmit information about a road, and the information about a road may include various information related to the road, such as the width of the road, the number of lanes, traffic volume, traffic lights, and crosswalks. In addition, the control server 200 may transmit a road traffic message (RTM), and the RTM may include information about accidents that occur on the road and affect driving, and may include information about traffic accidents, rallies, protests, events, road control, construction, disasters, etc. that suddenly occur.

Data that may be collected from the vehicle 100 and transmitted through a network may include data about the vehicle 100 itself, such as the year and type of the vehicle 100, data collected in relation to the surrounding environment of the vehicle 100, data collected to check the condition inside the vehicle 100, such as temperature and fuel amount, data about the driver, passengers, etc. riding in the vehicle 100, etc.

Below, operations performed by an apparatus for presenting driving information according to various embodiments of the present disclosure are described. The operations according to various embodiments may be understood to be performed by the vehicle 100 of FIG. 1, the device mounted on each of the vehicles 100, or a processor included in the device mounted on each of the vehicles 100.

The apparatus for presenting driving information, according to the present disclosure, may determine whether a first condition for initiating a background route guidance is met, and when the first condition is met, may initiate the background route guidance. The apparatus for presenting driving information, according to the present disclosure, may determine whether a second condition is met, and when the second condition for switching the background route guidance to a foreground route guidance is met, may receive a user input on whether to start the foreground route guidance. The apparatus for presenting driving information, according to the present disclosure, may initiate the foreground route guidance in response to receiving a user input.

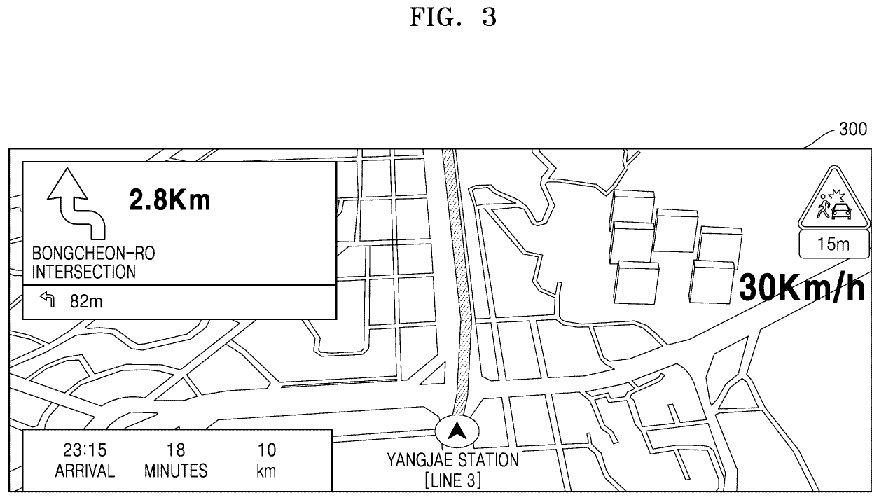

FIG. 3 is a diagram for describing a foreground route guidance according to the present disclosure.

In the present disclosure, the foreground route guidance may refer to a guidance that is displayed to a user (i.e., a driver or passenger of a vehicle) and is recognizable by the user. The apparatus for presenting driving information may, when providing the foreground route guidance, assist a vehicle in driving along a certain route toward a destination set by a user or a previously set destination.

In an embodiment, in the foreground route guidance, guidance on a route, guidance on a destination, guidance on an estimated arrival time, guidance on the remaining time, guidance on the remaining distance, guidance on route deviation, and guidance on alternative routes may be displayed to the user. Additionally, in an embodiment, in the foreground route guidance, basic guidance such as guidance on current speed, guidance on speeding, guidance on cameras on the road, guidance on entering a school safety zone, and guidance on accident-prone areas may be displayed to the user.

In the foreground route guidance, various guidance may be displayed through a voice output device or an image output device. For example, when it is determined that there is a route that takes less time to reach the same destination, the apparatus for presenting driving information may output voice, an image, an object, or an interface to provide guidance on the alternative route. For example, when a vehicle deviates from a previously guided route, the apparatus for presenting driving information may output voice, an image, an object, or an interface to provide guidance on the route deviation and guidance on a new route.

The apparatus for presenting driving information may update guidance in real time by collecting and displaying vehicle data, data about the vehicle's surroundings, information related to the road, and an RTM while providing the foreground route guidance.

Referring to FIG. 3, an example of a foreground route guidance interface 300 is illustrated. The foreground route guidance interface 300 may include a foreground route guidance that may be displayed visually. The apparatus for presenting driving information may generate and display the foreground route guidance interface 300 when initiating the foreground route guidance.

Referring to FIG. 3, the foreground route guidance interface 300 may include guidance on a visually displayed route (a line indicating the route and road guidance signs), guidance on a destination (the phrase “Yangjae Station [Line 3]”), guidance on an estimated arrival time (the phrase “arriving at 23:15”), guidance on the remaining time (the phrase “18 minutes”), and guidance on the remaining distance (the phrase “10 km”). Additionally, the foreground route guidance interface 300 may include guidance on accident-prone areas that are visually displayed (guidance display at the top right) and guidance on the current speed (the phrase “30 km/h”).

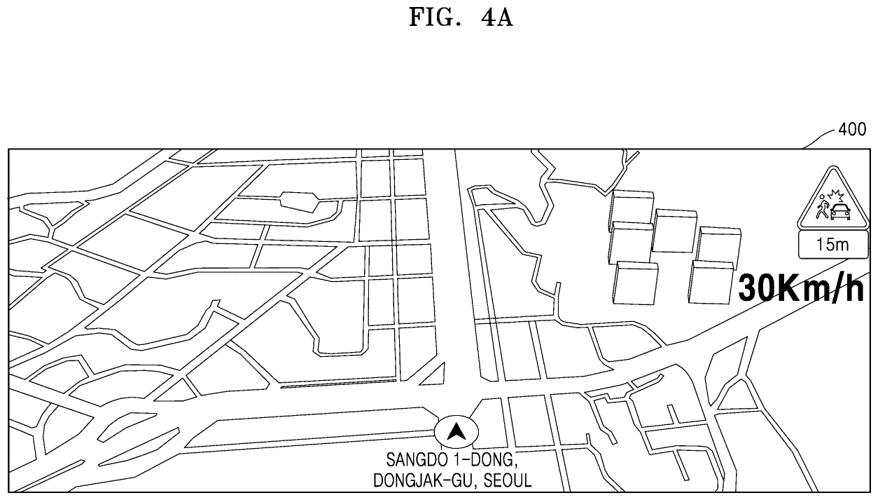

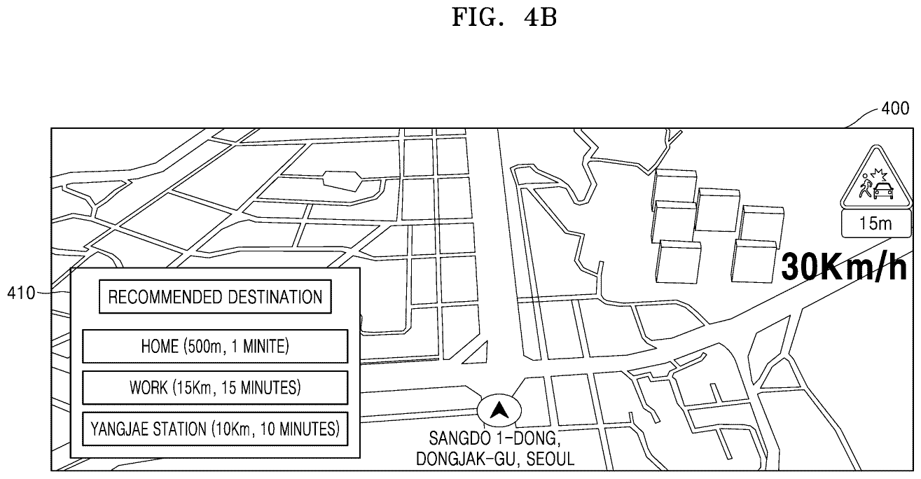

FIGS. 4A and 4B are diagrams for describing a basic driving guidance of the present disclosure.

In the present disclosure, the basic driving guidance may refer to guidance on providing information about driving of a vehicle and the road on which the vehicle is driving without a set destination or route. The apparatus for presenting driving information may, when providing the basic driving guidance, provide minimum information helpful for driving, based on the vehicle speed, the driving direction of the vehicle, and the location of the vehicle. In an embodiment, the basic driving guidance may display basic guidance to a user, such as guidance on current speed, guidance on speeding, guidance on cameras on the road, guidance on entering a school safety zone, and guidance on accident-prone areas.

In the basic driving guidance, various guidance may be displayed through a voice output device or an image output device. For example, when a vehicle is expected to enter a school zone, the apparatus for presenting driving information may output voice, an image, an object, or an interface to indicate that the vehicle is expected to enter a school zone. For example, when a vehicle is speeding, the apparatus for presenting driving information may output voice, an image, an object, or an interface to indicate that the vehicle is speeding.

Referring to FIG. 4A, an example of a basic driving guidance interface 400 is illustrated. The basic driving guidance interface 400 may be a basic driving guidance that may be displayed visually. The apparatus for presenting driving information may generate and display the basic driving guidance interface 400 when starting basic driving guidance.

Referring to FIG. 4A, the basic driving guidance interface 400 may include guidance on accident-prone areas that are visually displayed (guidance display at the top right) and guidance on the current speed (the phrase “30 km/h”). On the other hand, the basic driving guidance interface 400 is not based on a destination or route, and therefore may not include guidance on a route, guidance on a destination, guidance on an estimated arrival time, guidance on the remaining time, and guidance on the remaining distance.

Meanwhile, referring to FIG. 4B, the basic driving guidance interface 400 may further include a recommended destination object 410. In an embodiment, the recommended destination object 410 may be displayed on the basic driving guidance interface 400 only when the basic driving guidance is initiated and for a preset amount of time.

In an embodiment, the recommended destination object 410 may include information about one or more recommended destinations. One or more recommended destinations may be determined based on the vehicle's past destinations.

Referring to FIG. 4B, the recommended destination object 410 may include recommended destinations such as home, work, and Yangjae Station, and distances and estimated driving time for each of the recommended destinations.

In an embodiment, a user may interact with the recommended destination object 410 to input a recommended destination selection. In an embodiment, the apparatus for presenting driving information may initiate the foreground route guidance based on the selected destination when receiving an input for selecting a recommended destination.

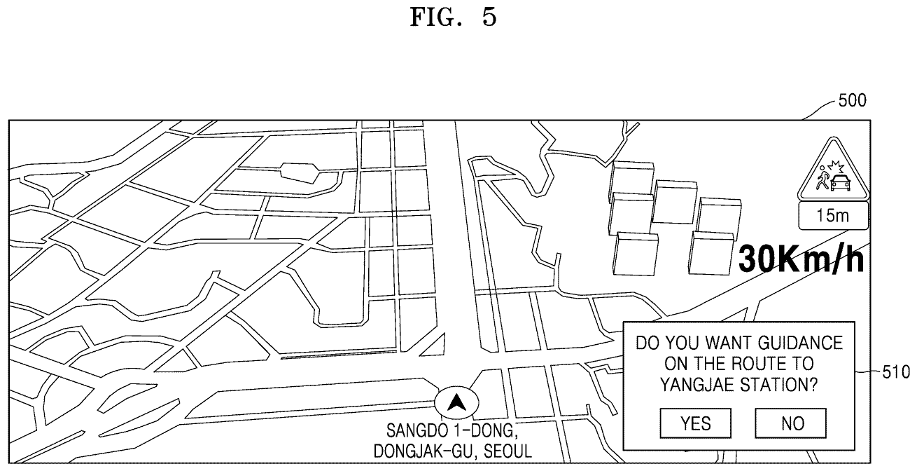

FIG. 5 is a diagram for describing a background route guidance of the present disclosure.

In the present disclosure, the background route guidance may refer to guidance that is not displayed to the user and therefore cannot be recognized by the user. The apparatus for presenting driving information may indirectly assist a vehicle in driving along a certain route toward a destination to which the vehicle is expected to travel, when the background route guidance is provided.

Unlike the basic driving guidance, the background route guidance shares the feature with the foreground route guidance in that a specific destination is set. However, unlike the foreground route guidance, the user does not need to set a destination for the background route guidance.

The apparatus for presenting driving information, according to the present disclosure, may provide the background route guidance without separately setting a destination or route, when a user has used a vehicle through a repetitive pattern and the user is expected to drive the vehicle in the same pattern as previously repeated patterns. If the user drives the vehicle in the same pattern, detailed guidance may not be required for routes that are already familiar to the user.

In an embodiment, in the background route guidance, guidance on the route, guidance on a destination, guidance on an estimated arrival time, guidance on the remaining time, guidance on the remaining distance, guidance on route deviation, and guidance on alternative routes may not be displayed to the user. On the other hand, in an embodiment, in the background route guidance, basic guidance such as guidance on current speed, guidance on speeding, guidance on cameras on the road, guidance on entering a school safety zone, and guidance on accident-prone areas may be displayed to the user. The display of various guidance in the background route guidance may be the same as the display of various guidance in the basic driving guidance.

The apparatus for presenting driving information may switch the background route guidance to the foreground route guidance when there is an obstacle to driving the vehicle in the same pattern, such as when the route in the pattern is closed. The apparatus for presenting driving information may collect vehicle data, data about the vehicle's surroundings, information related to the road, an RTM, etc. in real time to determine whether to switch the background route guidance to the foreground route guidance while providing the background route guidance.

Referring to FIG. 5, an example of a background route guidance interface 500 is illustrated. The background route guidance interface 500 may include a background route guidance that may be displayed visually. The apparatus for presenting driving information may generate and display the background route guidance interface 500 when starting the background route guidance.

Referring to FIG. 5, in an embodiment, the background route guidance interface 500 may be identical or similar to the basic driving guidance interface 400 of FIG. 4A or FIG. 4B. Additionally, the background route guidance interface 500 may include guidance on accident-prone areas that are visually displayed (guidance display at the top right) and guidance on the current speed (the phrase “30 km/h”). On the other hand, the background route guidance interface 500 is based on a destination or a route, but may not include guidance on the route, guidance on the destination, guidance on an estimated arrival time, guidance on the remaining time, and guidance on the remaining distance. This may be because, as described above, in the background route guidance, guidance on the route, guidance on the destination, guidance on the estimated arrival time, guidance on the remaining time, guidance on the remaining distance, guidance on route deviation, and guidance on alternative routes are not displayed to the user.

As will be described later, the apparatus for presenting driving information may suggest a switch to the foreground route guidance to the user when it is determined that the foreground route guidance is necessary.

Referring to FIG. 5, the background route guidance interface 500 may further include a foreground route guidance switch object 510. In an embodiment, the foreground route guidance switch object 510 may be displayed on the background route guidance interface 500 only for a preset period of time when the apparatus for presenting driving information determines that the foreground route guidance is necessary.

In an embodiment, a user may interact with the foreground route guidance switch object 510 to input whether to switch to the foreground route guidance. In an embodiment, the apparatus for presenting driving information may switch the background route guidance to the foreground route guidance based on a user input.

In the present disclosure, the apparatus for presenting driving information may determine whether a first condition is met, where the first condition may refer to a condition for initiating the background route guidance. In the present disclosure, the apparatus for presenting driving information may initiate the background route guidance in response to meeting of the first condition. In the present disclosure, the apparatus for presenting driving information may determine whether a second condition is met, wherein the second condition may refer to a condition for switching the background route guidance to the foreground route guidance.

As described above, the apparatus for presenting driving information, according to the present disclosure, may provide the background route guidance when the user is expected to drive the vehicle in a pattern identical to a repetitive pattern. In the present disclosure, the apparatus for presenting driving information may collect driving patterns and provide, based on the collected driving patterns, the background route guidance, the foreground route guidance, or the basic driving guidance.

The driving patterns of the present disclosure may be generated based on driving data representing various information related to a driving process of a vehicle. In an embodiment, the driving pattern may include information about a starting point, information about a destination, information about a route, information about the day of the week, information about a driving start time, and information about a required driving time.

For example, when a user drives from location 1 to location 2 on route 1 every Wednesday from 9:00 AM to 10:00 AM, a driving pattern may be generated in which the starting point is location 1, the destination is location 2, the route is route 1, the day of the week is Wednesday, the driving start time is 9:00 AM, and the required travel is 1 hour.

In an embodiment, the driving pattern may include information regarding a cumulative frequency of times the driving pattern has occurred. As described later, when there is already a driving pattern corresponding to new driving data, the cumulative frequency of driving patterns may increase.

In an embodiment, the driving pattern may be initially stored as a preliminary driving pattern, and converted and stored as a driving pattern when a cumulative frequency of preliminary driving patterns is greater than or equal to a threshold value.

In the present disclosure, an embodiment in which the apparatus for presenting driving information collects new driving data, updates a driving pattern, or generates a new driving pattern will be described in detail below.

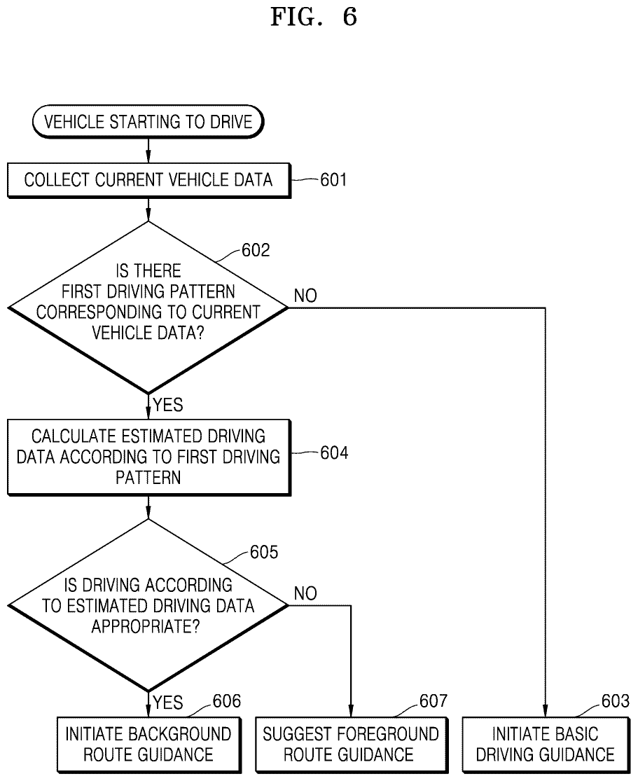

FIG. 6 is a flowchart of a process of initiating a background route guidance, according to an embodiment of the present disclosure.

As described above, the apparatus for presenting driving information may determine whether the first condition is met, wherein the first condition may be a condition for initiating the background route guidance. The apparatus for presenting driving information may initiate the background route guidance in response to meeting of the first condition.

In an embodiment, the apparatus for presenting driving information may determine whether the first condition is met in response to the vehicle starting to drive.

Referring to FIG. 6, in an embodiment, in response to a vehicle starting to drive, the apparatus for presenting driving information may collect current vehicle data (operation 601).

In the present disclosure, the current vehicle data refers to data about a vehicle at a time of collecting data, and specifically, current vehicle data may include a current location of the vehicle, a current date, a current day of the week, a current time, and the like.

Referring to FIG. 6, in an embodiment, the apparatus for presenting driving information may determine whether there is a first driving pattern corresponding to collected current vehicle data (operation 602).

The apparatus for presenting driving information may determine whether there is a driving pattern corresponding to the current vehicle data among one or more generated and stored driving patterns. If there is a driving pattern corresponding to the current vehicle data among the one or more driving patterns, that driving pattern may be the first driving pattern. If there is no driving pattern corresponding to the current vehicle data among the one or more driving patterns, it may be determined that there is no first driving pattern.

In an embodiment, whether there is a driving pattern corresponding to the current vehicle data may be determined based on whether information included in each of the current vehicle data and the driving pattern match each other. That is, the apparatus for presenting driving information may determine whether there is the first driving pattern that includes information identical to information included in the current vehicle data. When the current location of the vehicle, the current day of the week, and the current time of the current vehicle data and the starting point, the day of the week, and the driving start time of the first driving pattern are identical to each other, respectively, it may be determined that there is the first driving pattern corresponding to the current vehicle data.

For example, when a distance between the coordinates of the location of the current vehicle of the current vehicle data and the coordinates of the starting point of the driving pattern is less than or equal to a threshold value, for example, less than or equal to 100 meters, the coordinates of the current location of the vehicle of the current vehicle data may be considered to be identical to the starting point of the driving pattern. For example, when a difference between the current time of the current vehicle data and the driving start time of the driving pattern is less than or equal to a threshold value, for example, less than or equal to 10 minutes, the current time of the current vehicle data may be considered to be identical to the driving start time of the driving pattern.

Referring to FIG. 6, in an embodiment, the apparatus for presenting driving information may initiate a basic driving guidance (operation 603) when it is determined that there is no first driving pattern, i.e., a driving pattern corresponding to the current vehicle data.

That is, the apparatus for presenting driving information may determine that there is no need to initiate the background route guidance when the first driving pattern does not exist, and may only provide the basic driving guidance.

The apparatus for presenting driving information may initiate the basic driving guidance (operation 603) by displaying the basic driving guidance interface 400 described above.

Referring to FIG. 6, in the embodiment, the apparatus for presenting driving information may, when determining that there is the first driving pattern, i.e., a driving pattern corresponding to the current vehicle data, calculate estimated driving data according to the first driving pattern (operation 604).

In the present disclosure, the estimated driving data may refer to data representing various information related to an estimated driving process until reaching a destination, based on a route of the first driving pattern. In an embodiment, the estimated driving data may include information about a starting point, information about a destination, information about a route, information about the day of the week, information about a driving start time, and information about an estimated driving time.

In an embodiment, information about the starting point of the estimated driving data, information about the day of the week, and information about the driving start time may be derived based on the current location, the current day of the week, and the current time according to the current vehicle data. In an embodiment, since the estimated driving data is calculated based on the first driving pattern, information about the destination of the estimated driving data, and information about the route may be calculated based on the destination of the first driving pattern and the route of the first driving pattern. In an embodiment, the estimated driving time of the estimated driving data may be an estimated driving time, and the estimated driving time may be calculated based on information about the route of the estimated driving data and the driving start time.

Referring to FIG. 6, in an embodiment, the apparatus for presenting driving information may determine whether driving is appropriate according to the estimated driving data (operation 605).

In an embodiment, the apparatus for presenting driving information may determine, based on various conditions, whether driving according to the estimated driving data is appropriate (operation 605).

For example, the apparatus for presenting driving information may determine that driving according to the estimated driving data is not appropriate when an estimated driving time according to the estimated driving data exceeds an average driving time of the first driving pattern. For example, the apparatus for presenting driving information may determine that driving according to the estimated driving data is not appropriate when a difference between an estimated driving time tₑ, and an average driving time t_{avg} of the first driving pattern, tₑ−t_{avg}, is greater than or equal to a threshold value. For example, the threshold value may be set to any appropriate value, such as a constant, for example, 10 minutes or 20 minutes, or a value proportional to the average driving time taken.

For example, the apparatus for presenting driving information may determine that driving according to the estimated driving data is not appropriate when there is a closed road on a route according to the estimated driving data, i.e., a route of the first driving pattern.

For example, the apparatus for presenting driving information may determine that driving according to the estimated driving data is not appropriate when there is an RTM regarding the route according to the estimated driving data, that is, the route of the first driving pattern.

In addition, the apparatus for presenting driving information may determine the suitability of driving according to the estimated driving data, based on any appropriate conditions.

Referring to FIG. 6, in an embodiment, the apparatus for presenting driving information may initiate a background route guidance (operation 606) when it is determined that driving according to the estimated driving data is appropriate.

In an embodiment, the apparatus for presenting driving information may initiate the background route guidance (operation 606) by displaying the background route guidance interface 500 described above.

The apparatus for presenting driving information may initiate the background route guidance based on the estimated driving data. The apparatus for presenting driving information may initiate the background route guidance based on a destination and a route of the estimated driving data.

The apparatus for presenting driving information may determine to provide the background route guidance by predicting that the user is going to use the vehicle according to a previous vehicle usage pattern and will not experience significant inconvenience even when the user uses the vehicle according to the vehicle usage pattern.

Referring to FIG. 6, in an embodiment, the apparatus for presenting driving information may suggest a foreground route guidance (operation 607) when it is determined that driving according to the estimated driving data is not appropriate.

The apparatus for presenting driving information may suggest the foreground route guidance (operation 607) to provide more appropriate route guidance while predicting that the user will move toward a destination according to an existing vehicle usage pattern.

In an embodiment, the apparatus for presenting driving information may suggest the foreground route guidance (operation 607) through any appropriate method. That is, the apparatus for presenting driving information may request a user input indicating whether to initiate the foreground route guidance. For example, the apparatus for presenting driving information may suggest the foreground route guidance (operation 607) by outputting voice through a voice output device. For example, the apparatus for presenting driving information may suggest the foreground route guidance (operation 607) by displaying an image, an object, or an interface through an image output device.

In an embodiment, the user may determine whether to initiate the foreground route guidance. For example, the user may interact with the apparatus for presenting driving information, to input whether to initiate the foreground route guidance.

In an embodiment, the apparatus for presenting driving information may initiate the foreground route guidance when the user approves the suggestion of the foreground route guidance, and initiate the basic driving guidance when the user does not approve the foreground route guidance. In an embodiment, the user input may indicate either an approval or a disapproval, and in another embodiment, a user input may be considered as an approval, and the absence of a user input may be considered as a disapproval. For example, the user may input approval via a voice input device or via an image output device (e.g., a touchscreen).

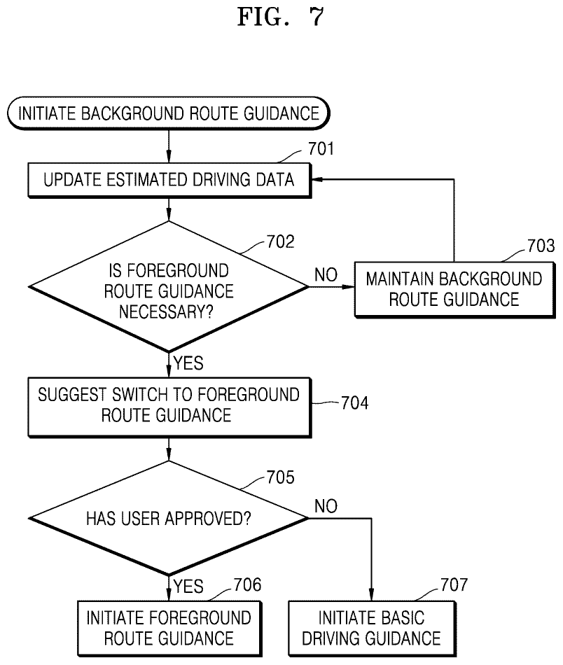

FIG. 7 is a flowchart of a process of switching a background route guidance to a foreground route guidance, according to an embodiment of the present disclosure.

As described above, the apparatus for presenting driving information may determine whether a second condition is met, wherein the second condition may be a condition for switching a background route guidance to a foreground route guidance.

Referring to FIG. 7, in an embodiment, the apparatus for presenting driving information may update estimated driving data (operation 701) after starting a background route guidance.

In an embodiment, the apparatus for presenting driving information may continuously update the estimated driving data calculated according to the first driving pattern after initiating the background route guidance.

In an embodiment, the estimated driving data may include information about a starting point, information about a destination, information about a route, information about the day of the week, information about a driving start time, and information about an estimated driving time. In an embodiment, the destination of the estimated driving data may be the destination of the first driving pattern, the route of the estimated driving data may be the route of the first driving pattern, and the estimated driving time of the estimated driving data may be the time expected to be taken when driving along the route according to the first driving pattern.

In an embodiment, the apparatus for presenting driving information may periodically collect information in real time or to update the estimated driving data (operation 701). For example, the apparatus for presenting driving information may update the estimated driving data (operation 701) based on information received from a control server or an external traffic system.

In an embodiment, the estimated driving data may include an RTM on the route of the estimated driving data.

Referring to FIG. 7, in an embodiment, the apparatus for presenting driving information may determine whether the foreground route guidance is necessary (operation 702).

The apparatus for presenting driving information may determine whether the foreground route guidance is necessary (operation 702) based on the updated estimated driving data.

In an embodiment, the apparatus for presenting driving information may determine whether the foreground route guidance is necessary (operation 702), based on various conditions.

In an embodiment, the apparatus for presenting driving information may determine that the foreground route guidance is necessary when, based on an update, an estimated time required or an estimated arrival time when driving along a route of estimated driving data (or, the first driving pattern) increases by a threshold value or more. For example, the apparatus for presenting driving information may determine that the foreground route guidance is necessary when a difference between the estimated arrival time after the update, tₐ₂, and the estimated arrival time before update, tₐ₁, tₐ₂−tₐ₁, is greater than or equal to a threshold value. For example, the threshold value may be set to any appropriate value, such as a constant such as 10 minutes or 20 minutes, or a value proportional to the estimated time before the update. As another example, when the estimated driving time does not decrease or the estimated arrival time increases despite multiple updates to the estimated driving data, it may be determined that the foreground route guidance is needed. For example, the apparatus for presenting driving information may determine that the foreground route guidance is necessary when the estimated driving time does not decrease for 5 minutes.

In an embodiment, the apparatus for presenting driving information may determine that the foreground route guidance is necessary when the vehicle deviates from the route of the estimated driving data (or the first driving pattern).

In an embodiment, the apparatus for presenting driving information may determine whether the vehicle deviates from the route of the first driving pattern.

In an embodiment, the apparatus for presenting driving information may determine that the vehicle deviates from the route of the first driving pattern, based on information about the location of the vehicle and roads forming the route of the first driving pattern. In an embodiment, the apparatus for presenting driving information may determine that the vehicle deviates from the route of the first driving pattern when the location of the vehicle is calculated to be deviating from any one of the roads forming the route of the first driving pattern by a threshold distance or greater. For example, the threshold distance may be any appropriate value, such as 5 meters, 10 meters, etc.

The apparatus for presenting driving information may consider a situation in which the foreground route guidance is still not necessary even when the vehicle deviates from the route of the first driving pattern. For example, the apparatus for presenting driving information may determine that a situation in which the foreground route guidance is not necessary is occurring, based on the level of a first road, even when the location of the vehicle is calculated to have deviated from the first road among the roads forming the route of the first driving pattern by the threshold distance or more. For example, the level of a road may be determined based on the dimensions of the road, such as road width, speed limit, etc. For example, when the first road, where the location of the vehicle is calculated to be greater than or equal to the threshold distance away, is less than two lanes in each direction, the apparatus for presenting driving information may determine that the foreground route guidance is not necessary. On the other hand, when the first road, where the location of the vehicle is calculated to be greater than or equal to the threshold distance away, is a road with a speed limit of 80 km/h, the apparatus for presenting driving information may determine that the foreground route guidance is necessary.

In an embodiment, the apparatus for presenting driving information may determine that the foreground route guidance is necessary when an RTM is generated on the route of the estimated driving data (or, the first driving pattern).

In addition, the apparatus for presenting driving information may determine whether the foreground route guidance is necessary based on any appropriate conditions.

Referring to FIG. 7, in an embodiment, the apparatus for presenting driving information may maintain the background route guidance (operation 703) when it is determined that the foreground route guidance is not necessary. Thereafter, the apparatus for presenting driving information may repeat updating the estimated driving data (operation 701).

Referring to FIG. 7, in an embodiment, the apparatus for presenting driving information may, when it is determined that the foreground route guidance is necessary, suggest to switch to the foreground route guidance to the user (operation 704).

In an embodiment, the apparatus for presenting driving information may suggest a switch to the foreground route guidance (operation 704) through any appropriate method. That is, the apparatus for presenting driving information may request a user input indicating whether to initiate the foreground route guidance. For example, the apparatus for presenting driving information may output voice through a voice output device to suggest a switch to the foreground route guidance (operation 704). For example, the apparatus for presenting driving information may suggest a switch to the foreground route guidance (operation 704) by displaying an image, an object, or an interface through an image output device. For example, the apparatus for presenting driving information may display the foreground route guidance switch object 510 described above.

In an embodiment, the user may decide whether to initiate the foreground route guidance. For example, the user may interact with the apparatus for presenting driving information and input an input indicating whether to initiate the foreground route guidance.

Referring to FIG. 7, in an embodiment, the apparatus for presenting driving information may determine whether a user has approved the switch to the foreground route guidance (operation 705).

In an embodiment, the apparatus for presenting driving information may initiate the foreground route guidance or the basic driving guidance in response to receiving a user input. In an embodiment, the user input may indicate either an approval or a disapproval, and in another embodiment, a user input may be considered as an approval, and the absence of a user input may be considered as a disapproval. For example, the user may input an approval via a voice input device or via an image output device (e.g., a touchscreen).

Referring to FIG. 7, in an embodiment, the apparatus for presenting driving information may initiate the foreground route guidance (operation 706) in response to a user's approval.

In an embodiment, the user may interact with the apparatus for presenting driving information, to input an input indicating whether to approve or disapprove the switch to the foreground route guidance, and the apparatus for presenting driving information may receive the user input and initiate the foreground route guidance (operation 706).

The apparatus for presenting driving information may initiate the foreground route guidance (operation 706) by displaying the foreground route guidance interface 300 described above.

As described above, guidance on the route, guidance on the destination, guidance on the estimated arrival time, guidance on the remaining time, guidance on the remaining distance, guidance on route deviation, and guidance on alternative routes may not be displayed to the user in background route guidance, but may be displayed to the user in the foreground route guidance. Accordingly, the apparatus for presenting driving information may initiate the foreground route guidance (operation 706) by displaying guidance on the route, guidance on the destination, guidance on the estimated arrival time, guidance on the remaining time, guidance on the remaining distance, guidance on route deviation, or guidance on an alternative route on the background route guidance interface 500.

Referring to FIG. 7, in an embodiment, the apparatus for presenting driving information may initiate a basic driving guidance (operation 707) in response to a user's disapproval.

The apparatus for presenting driving information may initiate the basic driving guidance (operation 707) by displaying the basic driving guidance interface 400 described above.

In an embodiment, the user may implicitly disapprove by not interacting with the apparatus for presenting driving information, and the apparatus for presenting driving information may, when not receiving an input from the user within a certain period of time, consider the user disapproving and initiate the basic driving guidance (operation 707) without initiating the foreground route guidance.

In an embodiment, the apparatus for presenting driving information may initiate the basic driving guidance (operation 707) and then perform again the process of determining whether the first condition is met (e.g., the process illustrated in FIG. 6). That is, the apparatus for presenting driving information may initiate the background route guidance at any time even after initiating the basic driving guidance (operation 707). Even when the basic driving guidance is initiated (operation 707), the apparatus for presenting driving information may continuously collect current vehicle data (operation 601) and determine whether there is a driving pattern corresponding to the current vehicle data (operation 602). When the apparatus for presenting driving information determines that there is a driving pattern corresponding to current vehicle data, the apparatus may calculate estimated driving data (operation 604) and determine whether to initiate the background route guidance based on the estimated driving data.

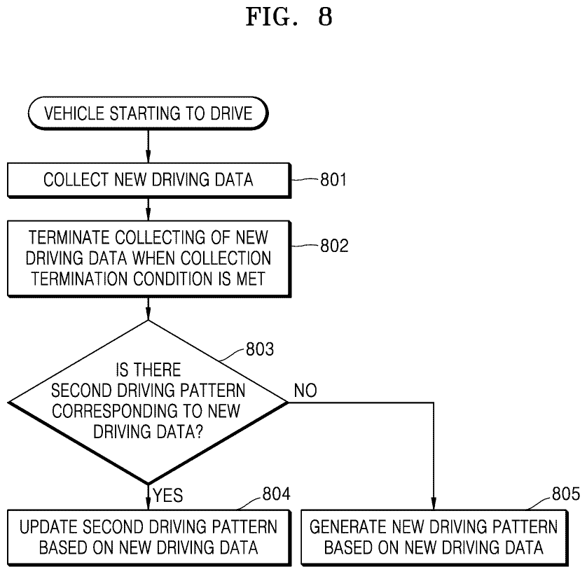

FIG. 8 is a flowchart of a process of generating a driving pattern, according to an embodiment of the present disclosure.

As described above, the apparatus for presenting driving information may collect new driving data and generate a driving pattern or update an existing driving pattern based on the new driving data.

Referring to FIG. 8, in an embodiment, the apparatus for presenting driving information may collect new vehicle data (operation 801) in response to a vehicle starting to drive.

Referring to FIG. 8, in an embodiment, the apparatus for presenting driving information may terminate the collecting of new driving data (operation 802) when a collection termination condition is met.

In the present disclosure, driving data may refer to data representing various information related to a driving process. The new driving data may be collected at a starting time when the vehicle starts driving, and may end at an end time when a condition for terminating collection is met.

In an embodiment, the driving pattern may include information about a starting point, information about a destination, information about a route, information about the day of the week, information about a driving start time, and information about a required driving time.

In an embodiment, information about the starting point, information about the day of the week, and information about the driving start time of the new driving data may be collected based on vehicle data at the starting time of collecting the new driving data. In an embodiment, information about the time required for the new driving data may correspond to a period of time between the starting time of the collecting of the new driving data and the end time. In an embodiment, information about a route of the new driving data may be collected based on a driving route of the vehicle between the starting time when the new driving data is collected and the end time.

In an embodiment, the collection termination condition of the new driving data may include any appropriate condition under which driving of the vehicle may be considered to have ended. For example, a vehicle's ignition turning off or a GPS being powered off could be considered as satisfying the collection termination condition. For example, when a vehicle is viewed to be stopped, the collection termination condition may be seen to be met. For example, the vehicle's gear being set to P may be viewed as satisfying the collection termination condition. For example, the vehicle speed becoming 0 and the vehicle's emergency lights turning on may be considered as satisfying the collection termination condition. In addition to these, various other conditions may be used, and the various conditions described above may be used in combination.

Referring to FIG. 8, in an embodiment, the apparatus for presenting driving information may determine whether there is a second driving pattern corresponding to the collected new driving data.

The apparatus for presenting driving information may determine whether a driving pattern corresponding to the new driving data exists among one or more generated and stored driving patterns. If there is a driving pattern corresponding to the new driving data among one or more driving patterns, that driving pattern may be the second driving pattern. If there is no driving pattern corresponding to the new driving data among one or more driving patterns, it may be determined that there is no second driving pattern.

In an embodiment, whether there is a driving pattern corresponding to new driving data may be determined based on whether pieces of information of the new driving data and the driving pattern are identical to each other. For example, when a distance between the coordinates of the starting point (or destination) of the new driving data and the coordinates of the starting point (or destination) of the driving pattern is less than or equal to a threshold value, for example, less than or equal to 100 meters, the starting point (or destination) of the new driving data and the starting point of the driving pattern may be considered to be identical to each other. For example, when the route of the new driving data and a route of a driving pattern match by a threshold ratio or more, for example, 80% or more, the route of the new driving data and the route of the driving pattern may be considered to be identical to each other. For example, when a difference between the departure time of the new driving data and the driving start time of the driving pattern is less than or equal to a threshold value, for example, less than or equal to 10 minutes, the departure time of the new driving data and the driving start time of the driving pattern may be considered to be identical to each other.

Referring to FIG. 8, in an embodiment, the apparatus for presenting driving information may, when it is determined that there is the second driving pattern, update the second driving pattern based on new driving data (operation 804).

For example, updating the second driving pattern may include recalculating a start time and an average driving time of the second driving pattern based on information about a start time and an average driving time of the new driving data. The departure time and the average driving time of the second driving pattern may be recalculated as the average of the accumulated departure times and the average of the accumulated average driving times. For example, updating the second driving pattern may include increasing a cumulative frequency of the second driving pattern. For example, updating the second driving pattern may include recalculating the starting point and the destination of the second driving pattern based on information about the starting point and the destination of the new driving data. The starting point and the destination of the second driving pattern may be recalculated as a centroid of the accumulated coordinates of the starting point and a centroid of the accumulated coordinates of the destination, respectively.

Referring to FIG. 8, in an embodiment, the apparatus for presenting driving information may generate a new driving pattern based on new driving data (operation 805) when it is determined that there is no second driving pattern.

The driving pattern generated may be used in the process of collecting new driving data later or determining whether to initiate the background route guidance.

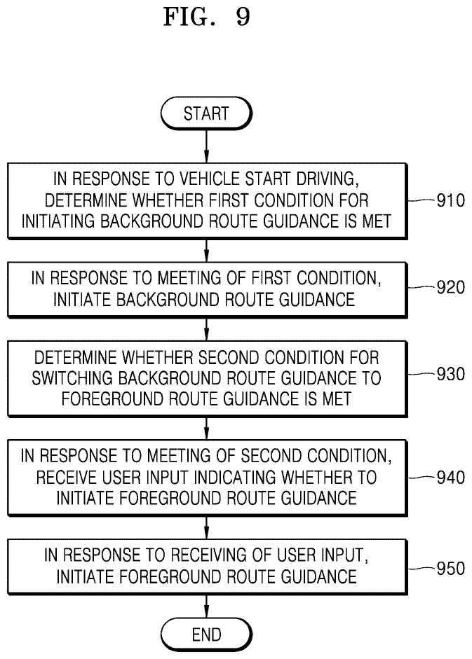

FIG. 9 is a flowchart of a method of presenting driving information, according to an embodiment of the present disclosure.

Operations illustrated in FIG. 9 may be executed by the apparatus for presenting driving information described above. The operations illustrated in FIG. 9 may be executed by a processor included in the apparatus for presenting driving information described above.

In operation 910, the processor may determine, in response to a vehicle starting to drive, whether the first condition for initiating the background route guidance is met.

In an embodiment, operation 910 may include collecting current vehicle data.

In an embodiment, operation 910 may include determining whether there is the first driving pattern corresponding to the current vehicle data.

In an embodiment, the current vehicle data may include information about the current location of the vehicle, the day of the week, and time.

In an embodiment, the first driving pattern may include information about a starting point, the day of the week, and a driving start time.

In an embodiment, whether there is the first driving pattern corresponding to the current vehicle data may be determined based on whether pieces of information included in the current vehicle data and the first driving pattern are identical to each other.

In an embodiment, operation 910 may include, in response to determining that there is the first driving pattern, calculating estimated driving data according to the first driving pattern.

In an embodiment, operation 910 may include determining whether driving is appropriate based on the estimated driving data.

In operation 920, the processor may initiate the background route guidance in response to meeting of the first condition.

In an embodiment, operation 920 may include displaying a background route guidance interface.

In operation 930, the processor may determine whether there is a second condition for switching background route guidance to the foreground route guidance is met.

In an embodiment, the second condition may include at least one of: an increase in an estimated arrival time at a destination by a threshold value or more when driving along the route of the first driving pattern, deviation of the vehicle from the route of the first driving pattern, and generation of a road traffic message on the route of the first driving pattern.

In operation 940, the processor may receive a user input indicating whether to initiate the foreground route guidance in response to meeting of the second condition.

In an embodiment, operation 940 may include displaying a foreground route guidance switch object in the background route guidance interface interactable with a user.

In operation 950, the processor may initiate the foreground route guidance in response to receiving the user input.

In an embodiment, initiating the foreground route guidance may include displaying guidance on the route, guidance on the destination, guidance on the estimated arrival time, and guidance on alternative routes in the background route guidance interface.

In an embodiment, the processor may collect new driving data.

In an embodiment, the processor may determine whether there is a second driving pattern corresponding to the new driving data.

In an embodiment, the processor may, in response to the presence of the second driving pattern, update the second driving pattern based on the new driving data, and in response to the absence of the second driving pattern, generate a new driving pattern based on the new driving data.

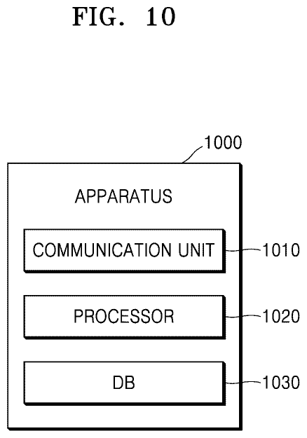

FIG. 10 is a block diagram of an apparatus for presenting driving information, according to an embodiment of the present disclosure.

Referring to FIG. 10, an apparatus 1000 for presenting driving information may include a communication unit 1010, a processor 1020, and a database (DB) 1030. Only components related to the embodiment are shown in the apparatus 1000 for presenting driving information, of FIG. 10. Accordingly, it will be understood by those skilled in the art that other general components may be included in addition to the components illustrated in FIG. 10.

The communication unit 1010 may include one or more components that enable wired/wireless communication with an external server or external device. For example, the communication unit 1010 may include at least one of a short-range communication unit (not shown), a mobile communication unit (not shown), and a broadcast receiving unit (not shown).

The DB 1030 may include hardware that stores various data processed within the apparatus 1000 for presenting driving information, and may store a program for processing and controlling the processor 1020. The DB 1030 may store payment information, user information, etc.

The DB 1030 may include random access memory (RAM) such as dynamic random-access memory (DRAM), static random-access memory (SRAM), read-only memory (ROM), electrically erasable programmable read-only memory (EEPROM), CD-ROM, Blu-ray or other optical disk storage, hard disk drive (HDD), solid state drive (SSD), or flash memory.

The processor 1020 controls the overall operation of the apparatus 1000 for presenting driving information. For example, the processor 1020 may control an input unit (not shown), a display (not shown), the communication unit 1010, the DB 1030, etc., by executing programs stored in the DB 1030. The processor 1020 may control the operation of the apparatus 1000 for presenting driving information by executing programs stored in the DB 1030.

The processor 1020 may control at least some of the operations of the apparatus 1000 for presenting driving information described above in FIGS. 1 to 9.

The processor 1020 may be implemented using at least one of application specific integrated circuits (ASICs), digital signal processors (DSPs), digital signal processing devices (DSPDs), programmable logic devices (PLDs), field programmable gate arrays (FPGAs), controllers, micro-controllers, microprocessors, and other electrical units for performing functions.

As an embodiment, the apparatus 1000 for presenting driving information may include a mobile electronic device. For example, the apparatus 1000 for presenting driving information may be implemented as a smartphone, a tablet PC, a PC, a smart TV, a personal digital assistant (PDA), a laptop, a media player, a navigation device, a device equipped with a camera, and other mobile electronic devices. In addition, the apparatus 1000 for presenting driving information may be implemented as a wearable device such as a watch, glasses, hair band, or ring equipped with a communication function and a data processing function.

In another embodiment, the apparatus 1000 for presenting driving information may include an electronic device embedded in a vehicle. For example, the apparatus 1000 for presenting driving information may be an electronic device that is inserted into a vehicle through tuning after the production process.

In another embodiment, the apparatus 1000 for presenting driving information may be a server located outside the vehicle. The server may be implemented as a computer device or multiple computer devices that communicate over a network to provide commands, codes, files, content, services, etc. The server may receive data necessary to determine a movement path of the vehicle from devices mounted on the vehicle, and determine the movement path of the vehicle based on the received data.

In another embodiment, the process performed in the apparatus 1000 for presenting driving information may be performed by at least some of an electronic device having mobility, an electronic device embedded in a vehicle, and a server located outside the vehicle.

The embodiments according to the present disclosure described above may be implemented in the form of a computer program that can be executed through various components on a computer, and the computer program may be recorded in a computer-readable medium. The medium may include magnetic media such as hard disks, floppy disks, and magnetic tapes, optical recording media such as CD-ROM and digital versatile disc (DVD), magneto-optical media such as floptical disks, and hardware devices specifically configured to store and execute program instructions, such as ROM, RAM, and flash memory.

The computer program may be specifically designed and configured for the present disclosure or may be well-known and available to one of ordinary skill in the art Examples of the program instructions include not only machine codes generated by using a compiler but also high-level language codes that may be executed on a computer by using an interpreter or the like.

According to an embodiment, the method according to various embodiments of the present disclosure may be provided as being included in a computer program product. The computer program product may be traded between sellers and buyers as commodities. The computer program product may be distributed in the form of a machine-readable storage medium (e.g., compact disc read only memory (CD-ROM)), or may be distributed online (e.g., by download or upload), via an application store (e.g., Play Store™), or directly between two user devices. In the case of online distribution, at least a portion of the computer program product may be temporarily stored or temporarily created in a machine-readable storage medium, such as a memory of a manufacturer's server, an application store's server, or an intermediary server.

Unless there is an explicit description or contradiction of the order of the steps constituting the method according to the present disclosure, the steps may be performed in any appropriate order. The present disclosure is not necessarily limited to the order in which the steps are described. The use of any and all examples, or exemplary language (e.g., “such as”) provided herein, is intended merely to better illuminate the present disclosure and does not pose a limitation on the scope of the present disclosure unless otherwise claimed. Furthermore, it will be obvious to those skilled in the art that various modifications, combinations and variations may be made according to design conditions and factors within the scope of the appended claims or their equivalents.

Therefore, the present disclosure should not be limited to the embodiments described above, and not only the scope of the claims described below but also all scopes equivalent to or equivalently modified from the scope of the claims are included in the scope of the present disclosure.

According to various embodiments of the present disclosure, as it is predicted that a user will drive a vehicle according to the same pattern as previously repeated patterns, detailed guidance on routes familiar to the user may be omitted, and when an unexpected obstacle occurs, appropriate assistance may still be provided, thereby providing the user with a pleasant driving experience.

In addition, various embodiments of the present disclosure are provided based on a driving pattern of the user, thereby providing a user-customized service.

Additionally, since the driving pattern of the user is continuously updated, the accuracy of guidance based on the driving pattern may be continuously improved.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A method of presenting driving information, the method comprising:
determining, in response to a vehicle starting to drive, whether a first condition for initiating a background route guidance is met;
initiating the background route guidance, in response to meeting of the first condition;
determining whether a second condition for switching the background route guidance to a foreground route guidance is met;
receiving, in response to meeting of the second condition, a user input indicating whether to initiate the foreground route guidance; and
initiating, in response to the receiving of the user input, the foreground route guidance.

2. The method of claim 1, wherein the determining whether the first condition is met comprises:
collecting current vehicle data; and
determining whether there is a first driving pattern corresponding to the current vehicle data.

3. The method of claim 2, wherein the determining whether the first condition is met comprises:
calculating, in response to the determining that there is the first driving pattern, estimated driving data according to the first driving pattern; and
determining whether driving according to the estimated driving data is appropriate.

4. The method of claim 2, wherein the current vehicle data comprises information about a location of a current vehicle, a day of the week, and time, and
the first driving pattern comprises information about a starting point, a day of the week, and a driving start time, and
whether there is the first driving pattern corresponding to the current vehicle data is determined based on whether pieces of information in the current vehicle data and the first driving pattern are identical to each other.

5. The method of claim 2, wherein the second condition comprises at least one of an increase in an estimated arrival time at a destination by a threshold value or more when driving along the route of the first driving pattern, deviation of the vehicle from the route of the first driving pattern, and generation of a road traffic message on the route of the first driving pattern.

6. The method of claim 1, further comprising:
collecting new driving data; and
determining whether there is a second driving pattern corresponding to the new driving data.

7. The method of claim 6, further comprising, updating, in response to the presence of the second driving pattern, the second driving pattern based on the new driving data, and generating, in response to the absence of the second driving pattern, a new driving pattern based on the new driving data.

8. The method of claim 1, wherein the initiating of the background route guidance comprises displaying a background route guidance interface, and
the receiving of the user input indicating whether to initiate the foreground route guidance comprises displaying a foreground route guidance switch object that is interactable with the user, on the background route guidance interface.

9. The method of claim 8, wherein the initiating of the foreground route guidance comprises displaying a guidance on a route, guidance on a destination, guidance on an estimated arrival time, and guidance on an alternative route on the background route guidance interface.

10. An apparatus for presenting driving information, the apparatus comprising:
a memory storing at least one program;
a processor configured to operate by executing the at least one program,
wherein the processor is further configured to:
determine, in response to a vehicle starting to drive, whether a first condition for initiating a background route guidance is met;
initiate the background route guidance, in response to meeting of the first condition;
determine whether a second condition for switching the background route guidance to a foreground route guidance is met;
receive, in response to meeting of the second condition, a user input indicating whether to initiate the foreground route guidance; and
initiate, in response to the receiving of the user input, the foreground route guidance.

11. A computer-readable recording medium having recorded thereon a program for causing the method of claim 1 to execute on a computer.
